(19) United States
(12) Patent Application Publication
(10) Pub. No.: US 2007/0008973 A1
(43) Pub. Date: Jan. 11, 2007

(54) Thin client server

(76) Inventor: Nicholas Paul Andrew Galea, Iklin (MT)

Correspondence Address: SEYFARTH SHAW LLP, 131 S. DEARBORN ST., SUITE2400, CHICAGO, IL, 60603-5803, US

(21) Appl. No.: 11/179,131

(22) Filed: Jul. 11, 2005

(51) Int. Cl. H04L 12/28

(52) U.S. Cl. 370/392; 370/401

(57) ABSTRACT

A thin client server 32 is adapted for communicating over a network with a thin client 31 configurable for operating with a terminal server 33. The thin client server comprises a database 321 for storing and retrieving thin client MAC addresses, user or group names and associated thin client configuration settings. The thin client server is arranged such that, on booting the thin client, configuration settings storable in the database relating to the said thin client are retrievable over the network by the thin client for use in operation with the terminal server.

### FIELD OF THE INVENTION

This invention relates to a thin client server and a method of configuring a thin client.

### BACKGROUND OF THE INVENTION

In thin client server applications a majority of data processing initiated at a thin client is performed at a terminal server to which the thin client is connected by a network. Data and applications are stored on the terminal server, from where the thin client obtains or downloads them. Because a bulk of data processing occurs on the terminal server, thin clients do not need all the memory, disk storage, and processor power provided on a typical personal computer.

Thin client server systems have an advantage of requiring greatly reduced support and administration. Thin clients are far easier to manage than standard client/server system because a thin client operating system is deployed centrally from the terminal server to the thin client and includes only a remote terminal client. Only the servers need to be managed, meaning that deploying patches, applications and virus updates is far easier than in, for example, networked personal computers (PCs). Enforcing desktop settings and backing up user files is easier too. Better security and fault tolerance is achieved by using RAID and housing the terminal servers in a secure, air-conditioned server room. Helping users is simple too: a user session may be shadowed from a central location in real time to monitor exactly what is happening at the thin client.

The actual thin client devices also have many advantages: they are far cheaper to purchase, do not have moving parts or fans, and therefore have a meantime before failure which is many times longer than a normal PC. They save on space, electricity and heat generation too: a thin client uses only a third of the power a PC uses and generates far less heat and noise, resulting in substantial savings.

Other features of thin clients include:
Thin clients can boot via PXE (Pre-boot Execution Environment), CD ROM, USB-connected device, floppy or hard disk;
Utilities may be provided to create boot floppies to allow PCs acting as thin clients to boot via PXE;
Thin clients can be configured to log to Syslog for easy troubleshooting;
Thin clients can be discovered via SNMP (Simple Network Management Protocol), allowing alternative network management software to be used if desired;
Thin clients log to a centralized Syslog database for easy analysis and troubleshooting;
Reports on sessions and user usage may be created.

To initiate operation, a known thin client boots a lean operating system after which the thin client connects to a terminal server using connection settings stored in the thin client. The connection settings may be managed remotely from a terminal server to which the thin client is connected. This means that the thin client is preconfigured to operate with predetermined terminal server software such as Microsoft® RDP (Remote Desktop Protocol) or Citrix ICA (Independent Computing Architecture) so that the connection settings need to be re-configured on the thin client whenever it is desired to operate with different terminal server software.

### SUMMARY OF THE INVENTION

According to a first aspect of the invention, there is provided a thin client server adapted for communicating over a network with a thin client configurable for operating with a terminal server, the thin client server comprising a database for storing and retrieving thin client MAC addresses, user or group names and associated thin client configuration settings, the thin client server being arranged such that, on booting a thin client, configuration settings storable in the database relating to the said thin client are retrievable over the network by the thin client for use in operation with the terminal server.

Preferably, the database is loaded with thin client MAC addresses, user or group names and associated thin client configuration settings.

According to a second aspect of the invention, there is provided a system comprising: a terminal server; a thin client configurable for operating with the terminal server, the thin client being identifiable by a thin client MAC address or user name; and a thin client server, assignable with a network address for communicating over a network with the thin client, wherein the thin client server includes a database for storing and retrieving a copy of the thin client MAC address, user or group name and associated configuration settings; arranged such that on booting the thin client the network address assigned to the thin client server is determinable by the thin client for passing the thin client MAC address or user name over the network to the thin client server and retrieving configuration settings corresponding to the said thin client MAC address, user or group name from the database for using the retrieved configuration settings to configure the thin client for operation with the terminal server.

Preferably, the system further comprises one of a storage device of the local client from which an operating system is loadable and a file transfer server from which the operating system is loadable.

Conveniently, the file transfer server comprises a Trivial File Transfer Protocol (TFTP) server.

Preferably, the system further comprises a network address assigning server from which a network address of the file transfer server is obtainable by the thin client.

Conveniently, the network address assigning server comprises a Dynamic Host Configuration Protocol (DHCP) server.

Advantageously, the Dynamic Host Configuration Protocol (DHCP) server is adapted for passing the network address of the thin client server to the thin client.

Alternatively, the system further comprises a network address translating server adapted for supplying the thin client with the network address of the thin client server.

Advantageously, the network address translating server comprises a Domain Name System (DNS) server.

Preferably, the thin client further comprises inputting means for inputting the user name to the thin client.

According to a third aspect of the invention, there is provided a method of configuring a thin client comprising the steps of: providing a thin client server comprising a database of thin client MAC addresses, user or group names and associated configuration settings; booting the thin client; determining an address of the thin client server; the thin client using the determined address for passing a thin client MAC address or user name from the thin client to the thin client server and retrieving configuration settings corresponding to the said thin client MAC address, user or group name from the database; and using the retrieved configuration settings to configure the thin client for communication with a terminal server.

Preferably, the step of booting the thin client comprises one of loading an operating system from a storage device of the thin client and loading the operating system from a file transfer server.

Conveniently, the step of loading the operating system from a file transfer server comprises loading the operating system from a Trivial File Transfer Protocol (TFTP) server.

Advantageously, the step of loading an operating system from a file transfer server comprises obtaining a network address of the file transfer server from a network address assigning server.

Conveniently, the step of obtaining a network address from a network address assigning server comprises obtaining a network address from a Dynamic Host Configuration Protocol (DHCP) server.

Conveniently, the step of determining the network address of the thin client server comprises passing the network address from the DHCP server.

Alternatively the step of determining the address of the thin client server comprises obtaining the network address from a network address translating server.

Conveniently, the step of obtaining the network address from a network address translating server comprises obtaining the network address from a Domain Name System (DNS) server.

Advantageously, the step of passing a thin client MAC address or user name from the thin client to the thin client server comprises inputting the user name to the thin client.

Conveniently, the step of inputting the user name to the thin client comprises inputting a username and password to the thin client.

According to a fourth aspect of the invention, there is provided computer executable software code stored on a computer readable medium, the code being for configuring a thin client comprising the steps of: providing a thin client server comprising a database of thin client MAC addresses, user or group names and associated configuration settings; booting the thin client; determining an address of the thin client server; the thin client using the determined address for passing a thin client MAC address or user name from the thin client to the thin client server and retrieving configuration settings corresponding to the said thin client MAC address, user or group name from the database; and using the retrieved configuration settings to configure the thin client for communication with a terminal server.

According to a fifth aspect of the invention, there is provided one or more programmed computers for configuring a thin client comprising the steps of: providing a thin client server comprising a database of thin client MAC addresses, user or group names and associated configuration settings; booting the thin client; determining an address of the thin client server; the thin client using the determined address for passing a thin client MAC address or user name from the thin client to the thin client server and retrieving configuration settings corresponding to the said thin client MAC address, user or group name from the database; and using the retrieved configuration settings to configure the thin client for communication with a terminal server.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

An embodiment of the present invention will now be described, by way of example only, with reference to the accompanying drawings, in which:

FIG. 1 is a block diagram illustrating a thin client being booted using PXE or Etherboot;

FIG. 2 is a block diagram showing retrieval of a thin client server IP address via a DNS (Domain Name System) server according to the invention;

FIG. 3 is a block diagram showing thin client connection settings being retrieved from a thin client server according to the invention, the address of the thin client server having been returned by the DNS server of FIG. 2; and

FIG. 4 is a flowchart of the method of configuring a thin client according to the invention.

### DETAILED DESCRIPTION OF PREFERRED EMBODIMENTS

Throughout the description, like reference numerals are used to identify like parts or steps.

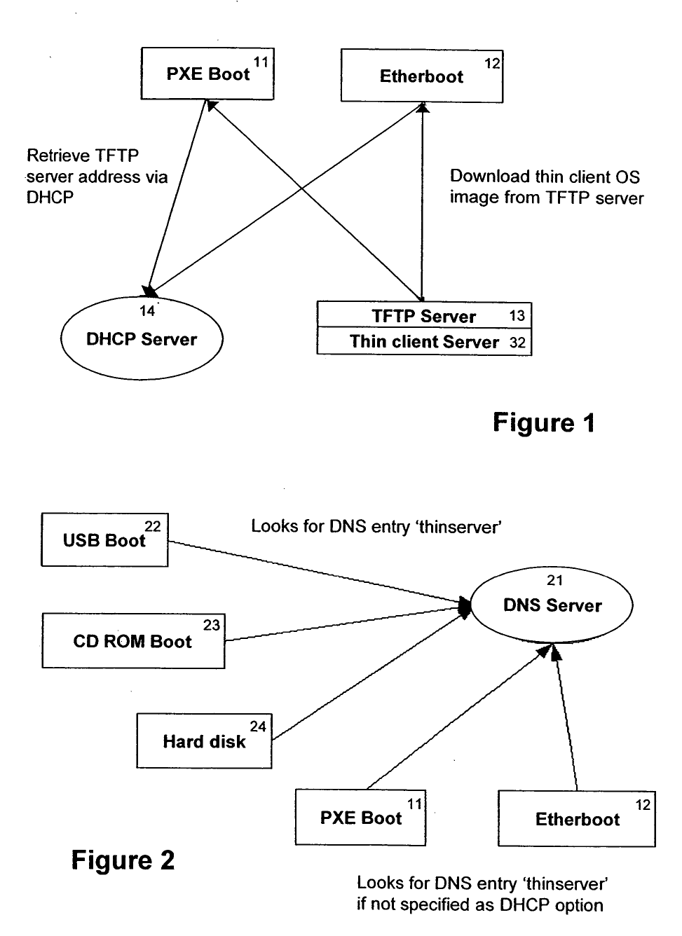

A thin client is a client computer for use in a client-server architecture network, which thin client has little or no application logic, so the thin client depends primarily on a central terminal server for processing activities. Referring to FIGS. 1 to 3, in a thin client server system according to the invention a thin client operating system is either downloaded from a file transfer protocol server 13 to a thin client 31 or loaded from local storage at the thin client. After the thin client operating system has booted the thin client operating system obtains configuration settings from the thin client server 32 and uses these configuration settings to connect to a terminal server 33.

Referring to FIGS. 1 to 4, the thin client operating system can either be downloaded, step 47, from a TFTP (Trivial File Transfer Protocol) server 13 or can be booted, step 43, from persistent memory or storage local to the thin client 31. Where the operating system is downloaded, step 47, from a server 13, a PXE (Pre-boot Execution Environment) boot 11 may be performed. A boot from PXE, which lies within a system BIOS of the client, allows the thin client 31 to boot from a server. Alternatively, an Etherboot 12 may be performed, Etherboot being a software package for creating ROM images that can download code over an Ethernet. Booting, step 43, from local persistent memory may be from, for example, a USB-connected memory device 22, CD ROM 23 or hard disk 24.

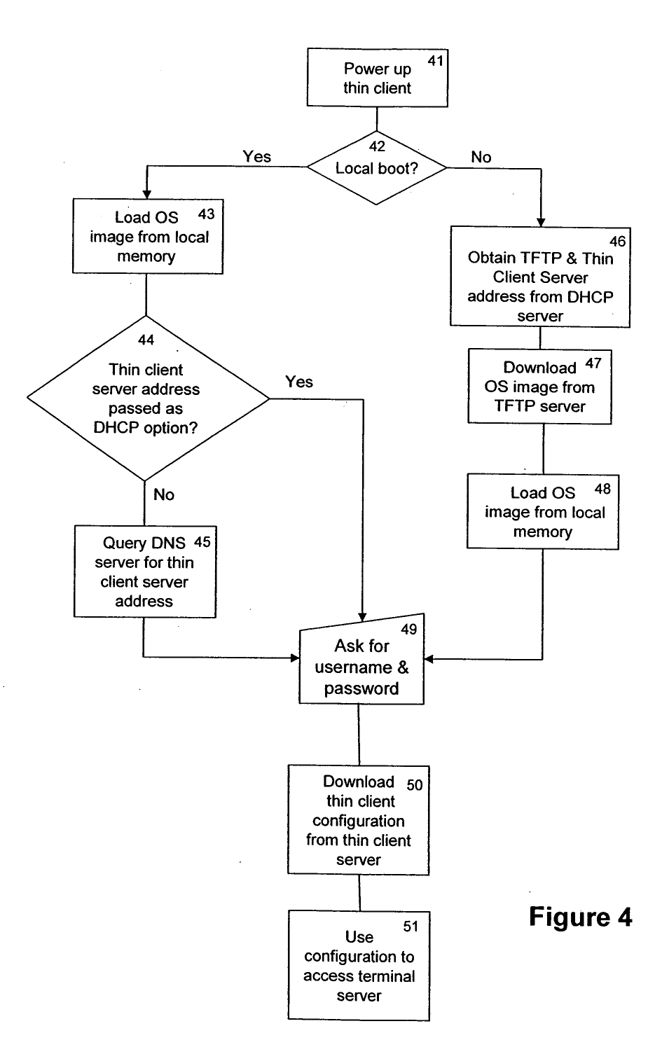

Alternative methods of booting a thin client are described in more detail by reference to FIG. 4. When the thin client 31 is powered up, step 41, dependent, step 42, on a BIOS setting, the thin client computer boots from a hard disk 24, PXE 11, Etherboot 12, a CD ROM 23 or a USB-connected memory device 22.

If an image of the thin client operating system is copied to, or installed on, a USB-connected memory device 22, a CD ROM 23 or the thin client hard drive 24, the thin client operating system will boot up, step 43, directly from the stored image and will not retrieve, step 47, an image from the TFTP server 13. Referring to FIGS. 2 and 4, after the thin client operating system has booted, the address of the thin client server 32 can be passed, step 44, by the DHCP server 14 using a DHCP option. Alternatively, the operating system finds a thin client server 32 by querying, step 45, a DNS (Domain Name Service) server 21 for a record called, for example, thinserver.

For PXE booting 11 or an Etherboot 12 (which is similar to PXE but does not rely on the computer BIOS) the thin client computer will obtain, step 46, the IP (Internet Protocol) address of the TFTP server 13 from a DHCP (Dynamic Host Configuration Protocol) server 14 via a DHCP broadcast over a network to which the thin client is connected. The TFTP server 13 will normally be installed on a same server as the thin client server 32 as shown in FIG. 1. The thin client computer 31 downloads, step 47, an operating system image from the TFTP server 13 and proceeds to boot up, step 48, the thin client using the downloaded image. Because the thin client operating system image is small (approximately 15 MB) this will be very fast. The thin client computer 31 will always download, step 47, the version of thin client operating system stored on the TFTP server 13.

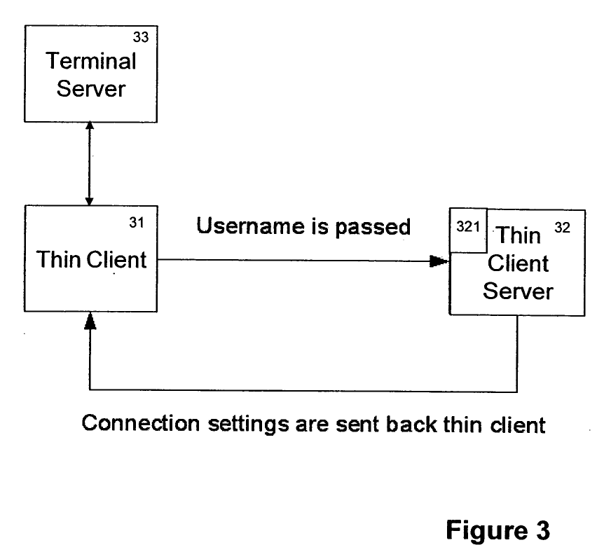

Referring to FIGS. 3 and 4, the operating system of the thin client 31 receives, step 49, a username and password from a user and passes this information and the MAC (Media Access Control) address securely to the thin client server 32 which searches for the username or MAC address in a settings database 321. The settings for the username, including to what type and to which terminal server the thin client 31 should connect, are retrieved from the database 321 and the thin client server 32 passes, step 50, the settings back to the thin client 31.

Rather than storing individual configuration settings for each user name, respective configuration profiles may be stored for respective groups of users. For example, a single Marketing Profile may be stored for all users within a Marketing Department. The groups would be present in the database, but at the thin client the user always inputs his/her user name. The thin client server then checks whether that username is part of a group and if so, associates the group settings with that user.

The thin client operating system is then able to run, step 51, an appropriate program (e.g. Rdesktop, Citrix Client or NX Client) with appropriate settings to connect the thin client 31 to an appropriate terminal server 33.

The system provides a capability to run different types of terminal server clients at run time, e.g. Microsoft RDP or Citrix ICA. This allows the type of terminal server to be changed centrally and dynamically at bootup, whereas in prior art systems this setting is preconfigured on the thin clients 31 and has to be changed on each thin client 31 which is required to run with a different type of terminal server.

Therefore the system permits the central deployment, configuration and management of thin clients 31 and provides load balancing and redundancy of terminal servers. Different types of thin client 31 are supported as are personal computers converted to thin clients. Thin client settings, e.g. screen size and which terminal server to log into, can be controlled centrally.

The thin client server 32 is independent of any thin client vendor: obsolescent computers, new low-cost computers and dedicated thin client devices from different vendors can be used and managed through one consistent and open interface. A user can flexibly choose appropriate new equipment and/or re-use old computer hardware. The thin client server 32 permits a lifespan extension of current computers by converting them to managed thin clients.

Because the thin client server 32 includes a thin client operating system and a centralized management interface for the thin clients, low-cost thin clients may be used which have no software pre-installed. The software is frequently a most expensive feature of a thin client.

Thin client users, profiles and hardware can be managed centrally via a web interface, allowing users to manage server-based computing infrastructure from anywhere on a network or even from outside a network. A web-based management interface may show currently active thin clients and user sessions. The management interface may also generate reports on sessions and include a centralized database of thin client ‘Syslog’ events, for easy troubleshooting and analysis.

Users or devices can be configured to boot thin client software such as RDP client (Windows) or an NX client (Linux) or any similar software. Because this can be changed easily from the web-based management interface, switching a user from Windows to Linux or vice versa is easy. No further configuration of the thin client is needed.

Thin clients can be configured to connect to a different terminal server if the primary terminal server is not available. This allows redundancy without requiring expensive and complex clustering hardware and software. Load balancing can be achieved by creating server groups, between which the thin client server will distribute a load.

Updates to the thin client operating system, which are only rarely required, are easily deployed: a latest version is downloaded from the management website and copied to the thin client server 32. Thin clients 31 booting from PXE 11 will then use the new operating system at a next boot-up. Thin clients booting from their hard disks can be remotely updated via the web-based interface.

Besides cost savings, thin client computing enables increased productivity by allowing workers to work from almost anywhere in the world. Employees can access their personal desktop from a fat client/notebook, making it easy to telework from home or while on the road. Workers have secure and instant access to enterprise applications and can be assured that their personal files are secure and free from viruses.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device.

Although the present invention has been described with reference to preferred embodiments, workers skilled in the art will recognize that changes may be made in form and detail without departing from the spirit and scope of the invention.

We claim:

1. A thin client server adapted for communicating over a network with a thin client configurable for operating with a terminal server, the thin client server comprising a database for storing and retrieving thin client MAC addresses, user or group names and associated thin client configuration settings, the thin client server being arranged such that, on booting a thin client, configuration settings storable in the database relating to the said thin client are retrievable over the network by the thin client for use in operation with the terminal server.

2. A thin client server as claimed in claim 1, wherein the database is loaded with thin client MAC addresses, user or group names and associated thin client configuration settings.

3. A system comprising: a terminal server; a thin client configurable for operating with the terminal server, the thin client being identifiable by a thin client MAC address or user name; and a thin client server, assignable with a network address for communicating over a network with the thin client, wherein the thin client server includes a database for storing and retrieving a copy of the thin client MAC address, user or group name and associated configuration settings; arranged such that on booting the thin client the network address assigned to the thin client server is determinable by the thin client for passing the thin client MAC address or user name over the network to the thin client server and retrieving configuration settings corresponding to the said thin client MAC address, user or group name from the database for using the retrieved configuration settings to configure the thin client for operation with the terminal server.

4. A system as claimed in claim 3 further comprising one of a storage device of the local client from which an operating system is loadable and a file transfer server from which the operating system is loadable.

5. A system as claimed in claim 4, wherein the file transfer server comprises a Trivial File Transfer Protocol (TFTP) server.

6. A system as claimed in claim 4, further comprising a network address assigning server from which a network address of the file transfer server is obtainable by the thin client.

7. A system as claimed in claim 6, wherein the network address assigning server comprises a Dynamic Host Configuration Protocol (DHCP) server.

8. A system as claimed in claim 7, wherein the Dynamic Host Configuration Protocol (DHCP) server is adapted for passing the network address of the thin client server to the thin client.

9. A system as claimed in claim 3, further comprising a network address translating server adapted for supplying the thin client with the network address of the thin client server.

10. A system as claimed in claim 9, wherein the network address translating server comprises a Domain Name System (DNS) server.

11. A system as claimed in claim 3, wherein the thin client further comprises inputting means for inputting the user name to the thin client.

12. A method of configuring a thin client comprising the steps of:
a. providing a thin client server comprising a database of thin client MAC addresses, user or group names and associated configuration settings;
b. booting the thin client;
c. determining an address of the thin client server;
d. the thin client using the determined address for passing a thin client MAC address or user name from the thin client to the thin client server and retrieving configuration settings corresponding to the said thin client MAC address, user or group name from the database; and
e. using the retrieved configuration settings to configure the thin client for communication with a terminal server.

13. A method as claimed in claim 12 wherein the step of booting the thin client comprises one of loading an operating system from a storage device of the thin client and loading the operating system from a file transfer server.

14. A method as claimed in claim 13, wherein the step of loading the operating system from a file transfer server comprises loading the operating system from a Trivial File Transfer Protocol (TFTP) server.

15. A method as claimed in claim 13, wherein the step of loading an operating system from a file transfer server comprises obtaining a network address of the file transfer server from a network address assigning server.

16. A method as claimed in claim 15, wherein the step of obtaining a network address from a network address assigning server comprises obtaining a network address from a Dynamic Host Configuration Protocol (DHCP) server.

17. A method as claimed in claim 16, wherein the step of determining the network address of the thin client server comprises passing the network address from the DHCP server.

18. A method as claimed in claim 12, wherein the step of determining the address of the thin client server comprises obtaining the network address from a network address translating server.

19. A method as claimed in claim 18, wherein the step of obtaining the network address from a network address translating server comprises obtaining the network address from a Domain Name System (DNS) server.

20. A method as claimed in claim 12, wherein the step of passing a thin client MAC address or user name from the thin client to the thin client server comprises inputting the user name to the thin client.

21. A method as claimed in claim 20, wherein the step of inputting the user name to the thin client comprises inputting a username and password to the thin client.

22. A method as claimed in claim 12, wherein the step of retrieving configuration settings comprises determining whether the user name is a member of a group corresponding to a stored group name and, if so, retrieving configuration settings corresponding to the group name.

23. Computer executable software code stored on a computer readable medium, the code being for configuring a thin client comprising the steps of:
a. providing a thin client server comprising a database of thin client MAC addresses, user or group names and associated configuration settings;
b. booting the thin client;
c. determining an address of the thin client server;
d. the thin client using the determined address for passing a thin client MAC address or user name from the thin client to the thin client server and retrieving configuration settings corresponding to the said thin client MAC address, user or group name from the database; and
e. using the retrieved configuration settings to configure the thin client for communication with a terminal server.

24. One or more programmed computers for configuring a thin client comprising the steps of:
a. providing a thin client server comprising a database of thin client MAC addresses, user or group names and associated configuration settings;
b. booting the thin client;
c. determining an address of the thin client server;
d. the thin client using the determined address for passing a thin client MAC address or user name from the thin client to the thin client server and retrieving configuration settings corresponding to the said thin client MAC address, user or group name from the database; and
e. using the retrieved configuration settings to configure the thin client for communication with a terminal server.
